(19) United States
(12) Patent Application Publication
(10) Pub. No.: US 2024/0290227 A1
(43) Pub. Date: Aug. 29, 2024

(54) Security Badge Device

(71) Applicant: Lisa LeBoeuf, Tomball, TX (US)

(72) Inventor: Lisa LeBoeuf, Tomball, TX (US)

(21) Appl. No.: 18/333,626

(22) Filed: Jun. 13, 2023

Related U.S. Application Data
(60) Provisional application No. 63/447,933, filed on Feb. 24, 2023.

(51) Int. Cl. G09F 3/20; G08B 25/01

(52) U.S. Cl. CPC G09F 3/207; G08B 25/016; G09F 2003/0279

(57) ABSTRACT

A security badge device is disclosed that is a badge holder for healthcare staff, school employees, office employees, etc. The security badge device comprises a body component that comprises a circular button that can be pressed one or more times to indicate a certain code. The button may be color coded and comprise a set of instructions available for users to learn to operate the device. Upon activation, a signal is then sent through an emergency system via a GPS tracker that tells the staff where in the building the user is and what is needed to assist the user calling for help. The number of times the button is pushed indicates what type of assistance is required.

### CROSS-REFERENCE TO RELATED APPLICATION

The present application claims priority to, and the benefit of, U.S. Provisional Application No. 63/447,933, which was filed on Feb. 24, 2023, and is incorporated herein by reference in its entirety.

### FIELD OF THE INVENTION

The present invention relates generally to the field of security badge devices. More specifically, the present invention relates to an improved security badge device for ID badges used in hospitals, schools, and other work settings. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in security badge devices. Generally, people who work in different settings while wearing an identification security badge (i.e., hospital, school, office building, etc.) may need to call for assistance due to an emergency. In these emergencies, using a phone may not be possible, and running for help may be dangerous. Accordingly, without a way to quickly ask for help, serious injury could occur.

Individuals that are alone and faced with an emergency situation often have little time to react before they can no longer seek assistance. Further, they may be in increased danger if they have to manipulate a complicated device or scroll through a menu to locate what they need. Further, some that are in need of assistance may be unable to react much at all because they are incapacitated and/or leaving to acquire help may be dangerous. For these reasons, portable personal emergency devices are needed.

Thus, there is a need in the art to provide for a personal emergency device for emergency notification, tracking, and safety that is easily transported and readily adopted by those at work, while also being something that they readily do not need to have with them when they are not at work. The device needs to be associated with their ID badge, such that it is readily carried with the individual, and is typically kept by the individual in a repeatable position on their body so they know where it is when they need it. Further, the device will also ideally be adapted to operate in and around the work environment.

Therefore, there exists a long-felt need in the art for a security badge device that provides users with an improved security badge device for ID badges used in hospitals, schools, and other work settings. There is also a long-felt need in the art for a security badge device that clips onto an employee's uniform and features an integrated GPS mechanism inside the clip that can be identified to locate a person on a digital map. Further, there is a long-felt need in the art for a security badge device that enables users to send a signal for help via a rotating, colored button that designates different emergency situations. Moreover, there is a long-felt need in the art for a device that ensures the proper code for an emergency is called so people coming to bring assistance are ready with the necessary tools or items. Further, there is a long-felt need in the art for a security badge device that offers the ability to program specific alerts into the button to make it more efficient and user friendly. Finally, there is a long-felt need in the art for a security badge device that is color coded with a set of instructions.

The subject matter disclosed and claimed herein, in one embodiment thereof, comprises a security badge device. The device is a badge holder for healthcare staff, school employees, office employees, etc. The security badge device comprises a body component that comprises a circular button that can be pressed one or more times to indicate a certain code. For example, the button may be pressed once for code blue, twice for nurse stat, etc. The button may be color coded and comprise a set of instructions available for users to learn to operate the device.

Upon activation, a signal is then sent through an emergency system via a GPS tracker that tells the staff where in the building the user is and what is needed to assist the user calling for help. The number of times the button is pushed indicates what type of assistance is required. Thus, by sending an alert quickly, help can be obtained, and serious injury can be prevented.

In this manner, the security badge device of the present invention accomplishes all of the foregoing objectives and provides users with a device that enables users to send a signal for help when needed. The device is an ID badge with a button to depress in case of emergency. The device can be available in different configurations and be retractable on the badge holder.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a security badge device. The device is a badge holder for healthcare staff, school employees, office employees, etc. The badge holder comprises a body component that comprises a circular button that can be pressed one or more times to indicate a certain code. The button may be color coded and comprise a set of instructions available for users to learn to operate the device. Upon activation, a signal is then sent through an emergency system via a GPS tracker that tells the staff where in the building the user is and what is needed to assist the user calling for help. The number of times the button is pushed indicates what type of assistance is required. Thus, by sending an alert quickly, help can be obtained, and serious injury can be prevented.

In one embodiment, the security badge device comprises a badge holder for healthcare workers, school employees, office employees, etc., or any other suitable personnel or employees as is known in the art that might be in need of emergency services. Further, it should be recognized that the badge holder may be designed to provide for certain aesthetic appearances (including overall shape, color, and style) and may also include company identifiers and the like printed or embossed on its surface. These aesthetic elements do not affect the operation of the device, but may alter the relative location of components from those depicted to have them fit into the desired structure as would be understood by one of ordinary skill in the art.

In one embodiment, the security badge device comprises a badge holder which is designed to incorporate an emergency notification component (i.e., a circular button) as part of its structure. The badge holder will typically include a badge sleeve for holding a pass or badge and a body component with a clip for holding the badge sleeve or the badge directly. The badge sleeve will typically comprise a sleeve formed of two layers of usually transparent or translucent material such as clear plastic. In an alternative embodiment, the front layer may be translucent and the back layer opaque or vice versa. A user will typically place a badge into the sleeve so that relevant portions of the badge are visible through the translucent layer for visual review by another user. In other embodiments, the badge may not include identifying information directly, but is simply a form of electronic “key” or the like to allow the holder access to certain areas. In such a case, the sleeve may be eliminated, and the clip may attach to the badge directly or the sleeve may be entirely opaque.

In one embodiment, the badge will typically comprise visual material such as a photograph and a name indicator. The badge may also have a visual indicator of an access status or similar concept. The badge will also typically include machine-readable material, such as, but not limited to, a bar code which would be visible to an optical scanner through the translucent layer. Alternatively, the badge may include a technology that does not require optical reading such as an Infra-red (IR), Bluetooth, or similar transmitter for proximity detection of the badge. If these later technologies are used, visual interrogation of the badge may be unnecessary and all badges in the same facility may actually appear effectively identical but have specific electronic or machine communicable characteristics.

Generally, it should be recognized that the badge can incorporate a large number of different features depending on the specifics of how it is to be used. For purposes of this disclosure, the important aspect is that the badge serves as an identifier of the associated user and will generally be used to allow the associated user to have access to particular parts of a workplace via any means or method of interrogation. As such, it needs to be readily accessible to the associated user while the user is in the workplace and typically may need to be visible on or about the user's person the vast majority of the time they are moving within the workplace (if not at all times they are in the workplace). This will allow for their identity to be regularly verified and for them to utilize the badge for access whenever necessary.

In one embodiment, the badge sleeve with a badge placed therein is placed on the second clip of the body component designed to incorporate a retractable badge reel or retractable badge clip. The body component will typically be attached to a belt, pocket, bag, or other object and allows the badge sleeve and badge to be extended from the body component of the badge holder while remaining attached to a retractable cable or similar object.

In one embodiment, the end of the cable will typically be attached to a swivel which is then attached to the clip. The swivel is not required but allows for the clip to be twisted about the cable without twisting the cable. This allows for flexibility in positioning the badge sleeve and avoids twisting of the cable and possibly creating increased tension or breakage.

In one embodiment, to connect to the cable, the badge sleeve will typically be attached via a clip or similar interconnector which is attached to the swivel. The clip will be designed to be attached to the badge sleeve (or to any other relevant object, such as the badge directly). The clip, in an embodiment, may be readily separable from the swivel (or the swivel may be readily separable from the cable) to alternatively be used to connect the sleeve directly to an object of the associated user such as by attaching it to clothing, for example.

In one embodiment, the body component includes the components of the reel mechanism or retractable cable. The body component comprises a front surface, a rear surface, and surrounding side walls. These surfaces may connect via any mechanism including, but not limited to, connectors such as screws or bolts, via friction such as through “snap” type connections, or via adhesives. Typically, attachment of the surfaces and side walls will be relatively permanent without it being expected that these surfaces would be separated in normal operation.

In one embodiment, the body component comprises a circular button that activates the emergency services. The body component is designed to support and protect the electronic components of the emergency services and button. The body component may also include a battery cover to provide for easy access to, while still supporting, the battery when the body component is opened.

Specifically, the emergency services comprise electronics to provide for various functions and a relatively large activation object or indicator, which is typically a depressible button. The button is disposed on the body component, so as to be easily accessible to the associated user of the device. While the activation object indicator in this embodiment is a button, it should be recognized that other objects may be used including, but not limited to, heat sensitive buttons, toggles, switches, motion, or other kinetic sensing devices, or any combination of such items.

Further, while the button in this embodiment is also a manual activation object where the associated user must purposefully activate it, the object need not require manual triggering and may be an indicator which is automatically triggered in other embodiments. For example, the activation object indicator can be a chemical, heat, or similar sensor, a motion sensor, or a light sensor.

In one embodiment, the button will typically be electrically interconnected with a circuit which will include the functionality of emergency notification. This functionality will typically depend on the nature of the work to which the badge is associated, and which is desired by the workplace manager. Generally, the circuit will typically include a power source which may be a chemical battery (rechargeable or disposable) or a power generator such as a solar panel or kinetic scavenger. The battery will typically provide power to a transmitter when the button is depressed which will be used to indicate activation of the emergency notification function of the device. The transmitter will typically be activated by depression of the button which will serve to have the transmitter send a signal via a network (whether local, global, or both) to a remote computer server. That server may then respond automatically, or, more typically, will send the notification to a human user for evaluation. In the event of automatic response, the server will often notify emergency personnel of an expected type that the emergency transmission has been activated. The notified personnel may be specific to the workplace (for example, a local security officer) or may be more general in nature (for example, a city's police force).

As part of the notification process, the device may send with, or as part of, the transmission, additional data. This will often include the location of the badge holder as determined by an on-board positioning system (i.e., a GPS positioning tracker, etc.). The device may also have other information stored in a memory, such as the identity of the user associated with the badge holder. In a still further embodiment, the device can obtain information from the badge should the badge have local communication capability, including the identity of the associated user to provide as part of the transmission.

In one embodiment, the body component can utilize a positioning system (i.e., a GPS positioning tracker, etc.) to record its locations and/or path of travel. The positioning system in this case can be an onboard positioning system or may be an external positioning system. In an embodiment of an external positioning system, the body component may “check-in” when it comes in range of a particular detector (for example, a particular beacon or combination of beacons) to indicate that it is in a particular room or location, or when it passes through a particular portal (such as a doorway) between particular locations. This “check-in” information can then be stored at a central computer facility to provide the current location of the body component and historical information can be used to provide a path that was taken by the body component over any particular time period. The positioning system in this case may be designed for use in a primarily outdoor area (for example, a satellite positioning system) if the facility has large outdoor areas (for example, a strip mine or forestry operation), primarily for indoor mapping (for example, in a factory, a school, a nursing home, an office, etc.), or a mixture of both (for example, in a large manufacturing campus).

In one embodiment, when the alarm is alerted, the body component comprises an integrated GPS tracker within the body component that identifies a user's location on a digital map. In one embodiment, when a general alarm (for example, a fire alarm, earthquake alarm, or an active shooter alarm) is triggered, every user may press the button on their body component. This can act as an indicator that the individual has heard the alarm and is evacuating. Quickly, a remote computer server may determine who has not triggered their button which may indicate a user is already incapacitated by the threat and in need of immediate assistance by their failure to activate the button.

In one embodiment, a user depresses the button to activate the emergency system. Generally, the button turns green once activated. Further, the button is color coded and comprises a set of instructions for users to learn what color signifies what emergency. For example, if the button is blue, there is a cardiac arrest emergency. If the button is red, there is a fire emergency. If the button is green, there is an inclement weather emergency. If the button is silver, there is an active shooter emergency. If the button is pink, there is an elopement emergency. A user would depress the button multiple times to access the specific color required. Specifically, the button is pressed one or more times to indicate a certain code. For example, the button may be pressed once for code blue, twice for nurse stat, etc. Once users learn the instructions as to what color signifies what emergency, the user can depress the button until the expected color is reached to alert a specific emergency. Thus, users can send an emergency signal for help via the rotating, colored button that designates different emergency situations. Further, the colored codes ensure that the proper code for a specific emergency is called, such that people coming to bring assistance are ready with the necessary tools or items.

Upon activation, a signal is then sent through the emergency system which tells staff where the user is within the building and what is needed to assist the user calling for help (i.e., what the specific emergency is). Thus, the staff knows where the user is in the building and depending on the number of times the button is pushed, what the emergency is and what assistance is required. Thus, by sending the alert quickly, help can be obtained, and serious injury can be prevented. Further, the security badge device offers the ability to program specific alerts into the button to make it more efficient and user friendly.

While the above embodiments provide for the device, to communicate with external computer systems fairly directly (i.e., such as through a network to a portable computer and/or central server), in a still further embodiment, the device may not directly interact with a remote server via a network. Instead, the device may access an associated user's mobile device which may be near to the body component and also carried by the associated user. The device may then transmit directly to the mobile device and the mobile device may utilize a transmitter in the mobile device to transmit the information to the network. This can allow for the device to have a reduced power requirement in transmission compared to if it were to access the network directly and to potentially have greater range.

While the above embodiments of the body component utilize a retracting reel, it should be recognized that this can be removed in alternative embodiments, and the body component may be designed to be attached to a lanyard, although that is optional, to be worn around the neck or may be connected via an attached clip or similar object to clothing or the like. The lanyard is typically simply a loop of material, such as, but not limited to, ribbon or fabric, which can be used to carry the badge sleeve around the neck in the manner that is well known to a person of ordinary skill in the art.

In yet another embodiment, the security badge device comprises a plurality of indicia.

In yet another embodiment, a method of sending an emergency signal for help when necessary is disclosed. The method includes the steps of providing a security badge device comprising a body component with a circular button that is color coded. The method also comprises activating the security badge device. Further, the method comprises clipping the security badge device to a user's clothes. The method comprises pressing the button to send an alert based on the color displayed. Finally, the method comprises sending an alert that tells the staff where the user is in the building and what is needed to assist the user calling for help.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the security badge device of the present invention showing the device worn by a nurse and activated in accordance with the disclosed architecture;

FIG. 2 illustrates a perspective view of one embodiment of the security badge device of the present invention showing the retractable badge clip in accordance with the disclosed architecture;

FIG. 3 illustrates a perspective view of one embodiment of the security badge device of the present invention showing the retractable badge clip in a different configuration in accordance with the disclosed architecture;

FIG. 4 illustrates a perspective view of one embodiment of the security badge device of the present invention showing instructions on the different colors of the button in accordance with the disclosed architecture;

FIG. 5 illustrates a perspective view of one embodiment of the security badge device of the present invention in use in a school setting in accordance with the disclosed architecture; and

FIG. 6 illustrates a flowchart showing the method of sending an emergency signal for help, when necessary, in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a security badge device that provides users with an improved security badge device for ID badges used in hospitals, schools, and other work settings. There is also a long-felt need in the art for a security badge device that clips onto an employee's uniform and features an integrated GPS mechanism inside the clip that can be identified to locate a person on a digital map. Further, there is a long-felt need in the art for a security badge device that enables users to send a signal for help via a rotating, colored button that designates different emergency situations. Moreover, there is a long-felt need in the art for a device that ensures the proper code for an emergency is called so people coming to bring assistance are ready with the necessary tools or items. Further, there is a long-felt need in the art for a security badge device that offers the ability to program specific alerts into the button to make it more efficient and user friendly. Finally, there is a long-felt need in the art for a security badge device that is color coded with a set of instructions.

The present invention, in one exemplary embodiment, is a novel security badge device. The device is a badge holder for healthcare staff, school employees, office employees, etc. The security badge device comprises a body component that comprises a circular button that can be pressed one or more times to indicate a certain code. The button may be color coded and comprise a set of instructions available for users to learn to operate the device. Upon activation, a signal is then sent through an emergency system via a GPS tracker that tells the staff where in the building the user is and what is needed to assist the user calling for help. The number of times the button is pushed indicates what type of assistance is required. The present invention also includes a novel method of sending an emergency signal for help when necessary. The method includes the steps of providing a security badge device comprising a body component with a circular button that is color coded. The method also comprises activating the security badge device. Further, the method comprises clipping the security badge device to a user's clothes. The method comprises pressing the button to send an alert based on the color displayed. Finally, the method comprises sending an alert that tells the staff where the user is in the building and what is needed to assist the user calling for help.

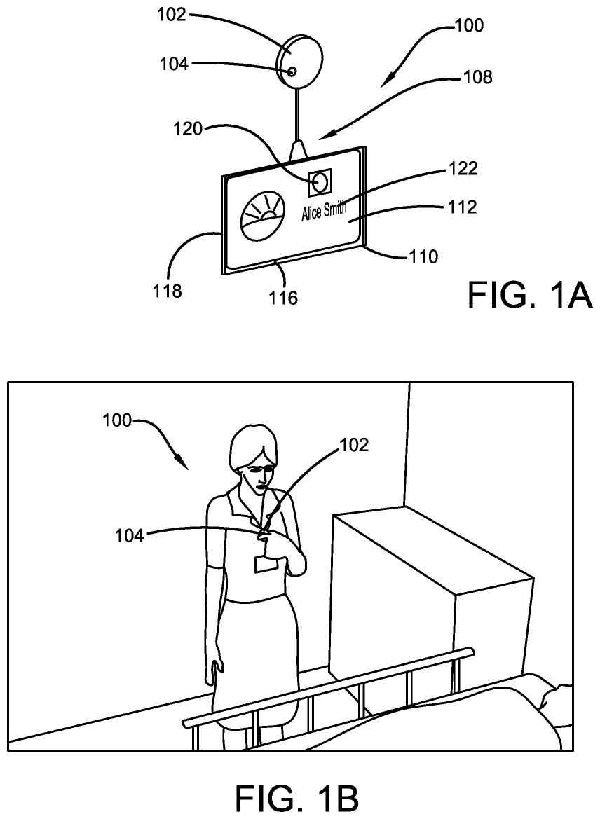

Referring initially to the drawings, FIGS. 1A-B illustrate a perspective view of one embodiment of the security badge device 100 of the present invention. In the present embodiment, the security badge device 100 is an improved security badge device 100 that enables a user 106 to send a signal for help via pushing a colored button 104. Specifically, the security badge device 100 comprises a body component 102 with a circular button 104 which can illuminate specific colors that indicate specific emergency situations. Accordingly, the button 104 is pressed one or more times to indicate a certain emergency code. Further, the button 104 includes a set of instructions, such that users 106 can learn to operate the color-coded button 104. Upon activation of the button 104, a signal is then sent through an emergency system via a GPS tracker that tells the staff where in the building the user 106 is and what is needed to assist the user 106 calling for help. Thus, by sending an alert quickly, help can be obtained, and serious injury can be prevented.

Generally, the security badge device 100 comprises a badge holder 108 for healthcare workers, school employees, office employees, etc., or any other suitable personnel or employees as is known in the art that might be in need of emergency services. Further, it should be recognized that the badge holder 108 may be designed to provide for certain aesthetic appearances (including overall shape, color, and style) and may also include company identifiers and the like printed or embossed on its surface. These aesthetic elements do not affect the operation of the device 100, but may alter the relative location of components from those depicted to have them fit into the desired structure as would be understood by one of ordinary skill in the art.

Furthermore, the security badge device 100 comprises a badge holder 108 which is designed to incorporate an emergency notification component (i.e., a circular button 104) as part of its structure. The badge holder 108 will typically include a badge sleeve 110 for holding a pass or badge 112 and a body component 102 with a clip 114 for holding the badge sleeve 110 or the badge 112 directly. The badge sleeve 110 will typically comprise a sleeve formed of two layers 116 and 118 of usually transparent or translucent material, such as clear plastic. In an alternative embodiment, the front layer 116 may be translucent and the back layer 118 may be opaque or vice versa. A user 106 will typically place a badge 112 into the sleeve 110 so that relevant portions of the badge 110 are visible through the translucent layer 116 for visual review by another user. In other embodiments, the badge 110 may not include identifying information directly, but is simply a form of electronic “key” or the like to allow the holder access to certain areas. In such a case, the sleeve 110 may be eliminated and the clip 114 may attach to the badge 112 directly or the sleeve 110 may be entirely opaque.

Additionally, the badge 112 will typically comprise visual material, such as a photograph 120 and a name indicator 122. The badge 112 may also have a visual indicator of an access status or similar concept. The badge 112 will also typically include machine-readable material, such as, but not limited to, a bar code which would be visible to an optical scanner through the translucent layer 116 or 118. Alternatively, the badge 112 may include a technology that does not require optical reading such as an Infra-red (IR), Bluetooth, or similar transmitter for proximity detection of the badge 112. If these later technologies are used, visual interrogation of the badge 112 may be unnecessary and all badges 112 in the same facility may actually appear effectively identical but have specific electronic or machine communicable characteristics.

Generally, it should be recognized that the badge 112 can incorporate a large number of different features depending on the specifics of how it is to be used. For purposes of this disclosure, the important aspect is that the badge 112 serves as an identifier of the associated user 106 and will generally be used to allow the associated user 106 to have access to particular parts of a workplace via any means or method of interrogation. As such, it needs to be readily accessible to the associated user 106 while the user 106 is in the workplace and typically may need to be visible on or about the user's person the vast majority of the time they are moving within the workplace (if not at all times they are in the workplace). This will allow for their identity to be regularly verified and for them to utilize the badge 112 for access whenever necessary.

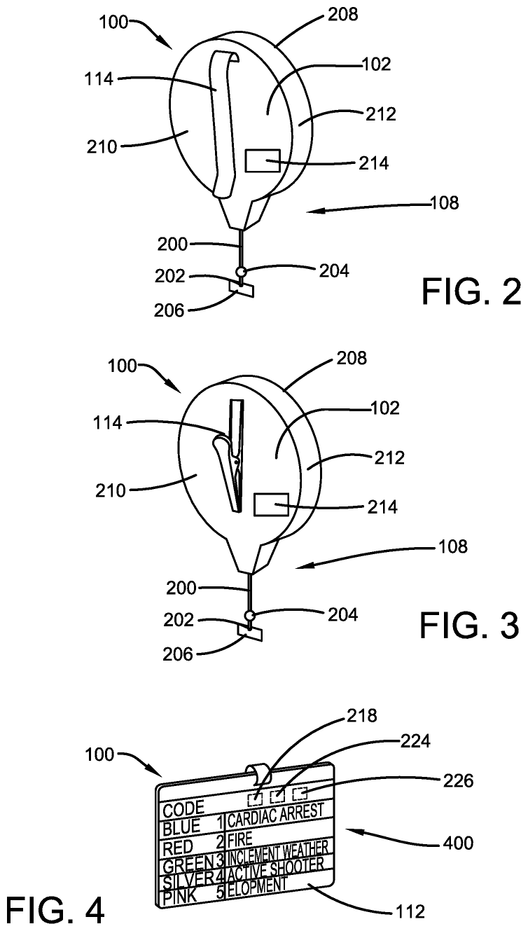

As shown in FIGS. 2-3, the badge sleeve 110, with a badge 112 placed therein, is placed on the second clip 206 of the body component 102 designed to incorporate a retractable badge reel 200 or retractable badge clip. The body component 102 will typically be attached to a belt, pocket, bag, or other object and allows the badge sleeve 110 and badge 112 to be extended from the body component 102 of the badge holder 108 while remaining attached to a retractable cable 200 or similar object. The second clip 206 can be any suitable clip as is known in the art, such as a clip that can be pinched together to open or a clip that is merely slid onto clothing, etc.

Furthermore, the end 202 of the cable 200 will typically be attached to a swivel 204 which is then attached to the clip 114. The swivel 204 is not required but allows for the clip 114 to be twisted about the cable 200 without twisting the cable 200. This allows for flexibility in positioning the badge sleeve 110 and avoids twisting of the cable 200 and possibly creating increased tension or breakage.

Additionally, to connect to the cable 200, the badge sleeve 110 will typically be attached via the clip 114 or similar interconnector which is attached to the swivel 204. The clip 114 will be designed to be attached to the badge sleeve 110 (or to any other relevant object, such as the badge 112 directly). The clip 114, in an embodiment, may be readily separable from the swivel 204 (or the swivel 204 may be readily separable from the cable 200) to alternatively be used to connect the sleeve 110 directly to an object of the associated user 106 such as by attaching it to clothing, for example.

Generally, the body component 102 includes the components of the reel mechanism or retractable cable 200. The body component 102 comprises a front surface 208, a rear surface 210, and surrounding side walls 212. These surfaces 208 and 210 may connect via any mechanism including, but not limited to, connectors such as screws or bolts, via friction such as through “snap” type connections, or via adhesives. Typically, attachment of the surfaces 208 and 210 and side walls 212 will be relatively permanent without it being expected that these surfaces 208 and 210 would be separated in normal operation.

In one embodiment, the body component 102 is circular in shape but can be any suitable shape as is known in the art, depending on the wants and/or needs of a user. Further, the body component 102 comprises a circular button 104 that activates the emergency services. The body component 102 is designed to support, house, and protect the electronic components of the emergency services and button 104. The body component 102 may also include a battery cover 214 to provide for easy access to, while still supporting, the battery 216 when the body component 102 is opened.

Specifically, the emergency services comprise electronics to provide for various functions and a relatively large activation object or indicator, which is typically a depressible button 104. The button 104 is disposed on the body component 102, so as to be easily accessible to the associated user 106 of the device 100. While the activation object indicator in this embodiment is a button 104, it should be recognized that other objects may be used including, but not limited to, heat sensitive buttons, toggles, switches, motion, or other kinetic sensing devices, or any combination of such items.

Further, while the button 104 in this embodiment is a manual activation object where the associated user 106 must purposefully activate it, the object need not require manual triggering and may be an indicator which is automatically triggered in other embodiments. For example, the activation object indicator can be a chemical, heat, or similar sensor, motion sensor, light sensor, etc.

In one embodiment, the button 104 will typically be electrically interconnected with a circuit which will include the functionality of emergency notification. This functionality will typically depend on the nature of the work to which the badge 112 is associated and which is desired by the workplace manager. Generally, the circuit will typically include a power source (i.e., battery 216) which may be a chemical battery (rechargeable or disposable) or a power generator, such as a solar panel or kinetic scavenger. The battery 216 will typically provide power to a transmitter 218 when the button 104 is depressed which will be used to indicate activation of the emergency notification function of the device 100. The transmitter 218 will typically be activated by depression of the button 104 which will serve to have the transmitter 218 send a signal via a network 220 (whether local, global, or both) to a remote computer server 222. That server 222 may then respond automatically, or, more typically, will send the notification to a human user 106 for evaluation. In the event of automatic response, the server 222 will often notify emergency personnel that the emergency transmission has been activated. The notified personnel may be specific to the workplace (for example, a local security officer) or may be more general in nature (for example, a city's police force), etc.

As shown in FIG. 4, as part of the notification process, the device 100 may send with, or as part of, the transmission, additional data. This will often include the location of the badge holder 108 as determined by an on-board positioning system (i.e., a GPS positioning tracker 224, etc.). The device 100 may also have other information stored in a memory 226, such as the identity of the user 106 associated with the badge holder 108. In a still further embodiment, the device 100 can obtain information from the badge 112, should the badge 112 have local communication capability, including the identity of the associated user 106 to provide as part of the transmission.

Generally, the body component 102 can utilize a positioning system (i.e., a GPS positioning tracker 224, etc.) to record its locations and/or path of travel. The positioning system in this case can be an onboard positioning system or maybe an external positioning system. In an embodiment of an external positioning system, the body component 102 may “check-in” when it comes in range of a particular detector (for example, a particular beacon or combination of beacons) to indicate that it is in a particular room or location, or when it passes through a particular portal (such as a doorway) between particular locations. This “check-in” information can then be stored at a central computer facility to provide the current location of the body component 102 and historical information can be used to provide a path that was taken by the body component 102 over any particular time period. The positioning system in this case may be designed for use in a primarily outdoor area (for example, a satellite positioning system) if the facility has large outdoor areas (for example, a strip mine or forestry operation), primarily for indoor mapping (for example, in a factory, a school, a nursing home, an office, etc.), or a mixture of both (for example, in a large manufacturing campus).

In one embodiment, when the alarm is alerted (i.e., the button 104 is depressed), the body component 102 comprises an integrated GPS tracker 224 within the body component 102 that identifies a user's location on a digital map. Accordingly, when a general alarm (for example, a fire alarm, earthquake alarm, or an active shooter alarm) is triggered, every user 106 may press the button 104 on their body component 102. This can act as an indicator that the individual has heard the alarm and is evacuating. Quickly, a remote computer server 222 may determine who has not triggered their button 104 which may indicate the user is 106 already incapacitated by the threat and in need of immediate assistance by their failure to activate the button 104.

In operation, a user 106 depresses the button 104 to activate the emergency system. Generally, the button 104 turns green once activated, or any other suitable color, as is known in the art. Further, the button 104 is color coded and comprises a set of instructions 400 for users 106 to learn what color signifies what emergency. For example, if the button 104 is blue, there is a cardiac arrest emergency. If the button 104 is red, there is a fire emergency. If the button 104 is green, there is an inclement weather emergency. If the button 104 is silver, there is an active shooter emergency. If the button 104 is pink, there is an elopement emergency. A user 106 would depress the button 104 multiple times to access the specific color required. Specifically, the button 104 is pressed one or more times to indicate a certain code based on the color illuminated. For example, the button 104 may be pressed once for code blue, twice for nurse stat, etc. Once users 106 learn the instructions 400 as to what color signifies what emergency, the user 106 can depress the button 104 until the expected color is reached to alert a specific emergency. Thus, users 106 can send an emergency signal for help via the rotating, colored button 104 that designates different emergency situations. Further, the colored codes ensure that the proper code for a specific emergency is called, such that people coming to bring assistance are ready with the necessary tools or items.

Upon activation, a signal is then sent through the emergency system which tells staff where the user 106 is within the building and what is needed to assist the user 106 calling for help (i.e., what the specific emergency is). Thus, the staff knows where the user 106 is in the building and depending on the number of times the button 104 is pushed, what the emergency is and what assistance is required. Thus, by sending the alert quickly, help can be obtained, and serious injury can be prevented. Further, the security badge device 100 offers the ability to program specific alerts into the button 104 to make it more efficient and user friendly.

In one embodiment, in operation, the button 104 doesn't have to be pushed or is not utilized and the body component 102 comprises an integrated GPS tracker 224 within the body component 102 that identifies a user's location on a digital map. Accordingly, when a general alarm (for example, a fire alarm, earthquake alarm, or an active shooter alarm) is triggered, the body component 102 acts as an indicator for that individual. Thus, if children go on a field trip, the children would have a body component 102 without a button 104 but would include the integrated GPS tracker 224, such that the children can be located via satellite (i.e., similar to life alert, life 360 etc.). Thus, if the children were lost off campus or kidnapped they could be located via the device 100 and accounted for. This could also be used for elderly people who would not be able to depress the button 104, (i.e., a nursing home could utilize the device 100 to locate lost residents or during a natural disaster). This body component 102 could be designed as a pin, a badge, a bracelet, etc.

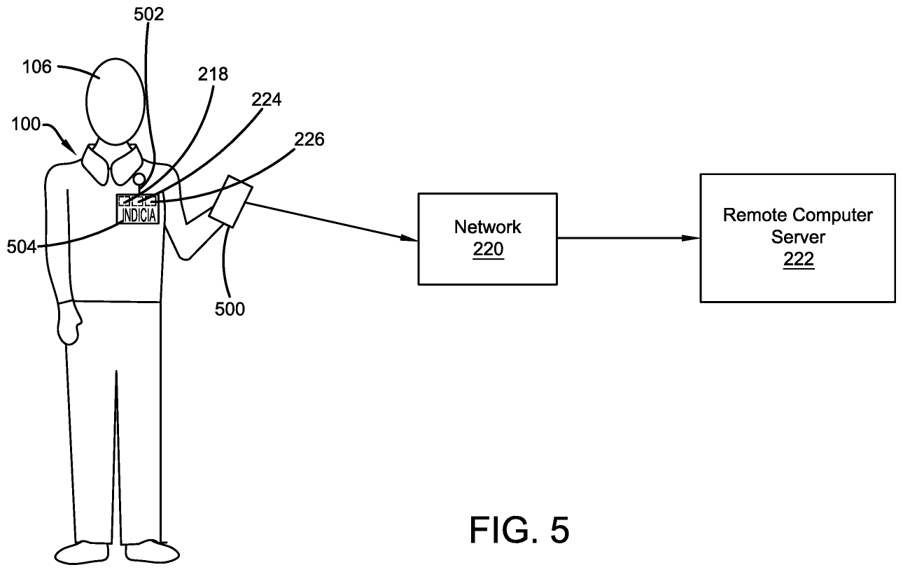

As shown in FIG. 5, while the above embodiments provide for the device 100 to communicate with external computer systems 222 fairly directly (i.e., such as through a network 220 to a portable computer and/or central server 222), in a still further embodiment, the device 100 may not directly interact with a remote server 222 via a network 220. Instead, the device 100 may access an associated user's mobile device 500 which may be near to the body component 102 and also carried by the associated user 106. The device 100 may then transmit directly to the mobile device 500 and the mobile device 500 may utilize a transmitter 218 in the mobile device 500 to transmit the information to the network 220. This can allow for the device 100 to have a reduced power requirement in transmission compared to if it were to access the network 220 directly and to potentially have greater range.

Further, while the above embodiments of the body component 102 utilize a retracting reel 200, it should be recognized that this can be removed in alternative embodiments and the body component 102 may be designed to be attached to a lanyard 502, although that is optional, to be worn around the neck or may be connected via an attached clip 114 or similar object to clothing or the like. The lanyard 502 is typically simply a loop of material, such as, but not limited to, ribbon or fabric, which can be used to carry the badge sleeve 110 around the neck in the manner that is well known to a person of ordinary skill in the art.

In yet another embodiment, the security badge device 100 comprises a plurality of indicia 504. The body component 102 of the device 100 may include advertising, trademark, other letters, designs, or characters, printed, painted, stamped, or integrated into the body component 102, or any other indicia 504 as is known in the art. Specifically, any suitable indicia 504 as is known in the art can be included, such as, but not limited to, patterns, logos, emblems, images, symbols, designs, letters, words, characters, animals, advertisements, brands, etc., that may or may not be ID badge, emergency, or brand related.

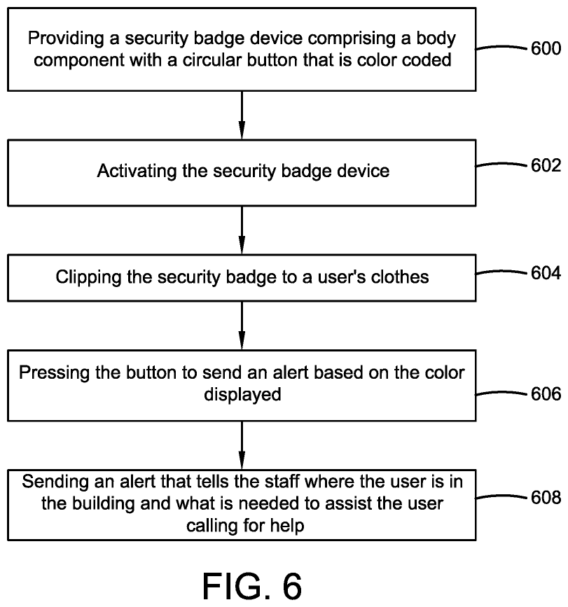

FIG. 6 illustrates a flowchart of the method of sending an emergency signal for help when necessary. The method includes the steps of at 600, providing a security badge device comprising a body component with a circular button that is color coded. The method also comprises at 602, activating the security badge device. Further, the method comprises at 604, clipping the security badge device to a user's clothes. The method comprises at 606, pressing the button to send an alert based on the color displayed. Finally, the method comprises at 608, sending an alert that tells the staff where the user Is in the building and what is needed to assist the user calling for help.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “security badge device”, “badge device”, “security device”, and “device” are interchangeable and refer to the security badge device 100 of the present invention.

Notwithstanding the foregoing, the security badge device 100 of the present invention can be of any suitable size and configuration as is known in the art without affecting the overall concept of the invention, provided that it accomplishes the above-stated objectives. One of ordinary skill in the art will appreciate that the security badge device 100 as shown in FIGS. 1-6 are for illustrative purposes only, and that many other sizes and shapes of the security badge device 100 are well within the scope of the present disclosure. Although the dimensions of the security badge device 100 are important design parameters for user convenience, the security badge device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A security badge device that enables a user to send a signal for help via pushing a color-coded button, the security badge device comprising:
a badge holder comprising a body component, a button and a second clip;
wherein the second clip secures the badge holder to a user's body;
wherein the button is housed within the body component;
wherein the button illuminates specific colors that indicate specific emergency situations; and
further wherein upon activation of the button, a signal is sent to alert others of an emergency to send help.

2. The security badge device of claim 1, wherein the badge holder is configured to be utilized by a healthcare worker, a school employee, or an office employee.

3. The security badge device of claim 2, wherein the badge holder will typically include a badge sleeve for holding a badge and a retractable cable and a clip for holding the badge sleeve or the badge directly.

4. The security badge device of claim 3, wherein the retractable cable is attached to a swivel which is then attached to the clip.

5. The security badge device of claim 4, wherein the body component comprises a front surface, a rear surface and surrounding side walls.

6. The security badge device of claim 5, wherein the body component houses a battery and a transmitter, wherein the battery provides power to a transmitter, when the button is depressed, which sends a signal via a network to a remote computer server, and further wherein the remote computer server will notify emergency personnel that an emergency transmission has been activated.

7. The security badge device of claim 6, wherein the body component comprises a GPS positioning tracker to determine its location.

8. The security badge device of claim 7, wherein the button is color coded and comprises a set of instructions for users to learn what color signifies what emergency.

9. The security badge device of claim 8, wherein a user would depress the button multiple times to access a specific color which indicates a certain code.

10. The security badge device of claim 9, wherein the security badge device accesses a user's mobile device, which then transmits directly to the network.

11. The security badge device of claim 10, wherein a lanyard is used to secure the badge holder to a user.

12. The security badge device of claim 11 wherein the body component does not comprise a button but comprises an integrated GPS tracker that identifies a user's location on a digital map.

13. A security badge device that enables a user to send a signal for help via pushing a color-coded button, the security badge device comprising:
a badge holder comprising a body component, a button and a second clip;
wherein the second clip secures the badge holder to a user's body;
wherein the button is housed within the body component;
wherein the badge holder will typically include a badge sleeve for holding a badge and a retractable cable and a clip for holding the badge sleeve or the badge directly;
wherein the body component houses a battery and a transmitter, wherein the battery provides power to a transmitter when the button is depressed, which sends a signal via a network to a remote computer server, wherein the remote computer server will notify emergency personnel that an emergency transmission has been activated;
wherein the body component comprises a GPS positioning tracker to determine its location;
wherein the button is color coded and comprises a set of instructions for users to learn what color signifies what emergency;
wherein a user would depress the button multiple times to access a specific color which indicates a certain code; and
further wherein upon activation of the button, a signal is sent to alert others of an emergency to send help.

14. The security badge device of claim 13 further comprising a plurality of indicia.

15. The security badge device of claim 13, wherein the security badge device accesses a user's mobile device, which then transmits directly to the network.

16. The security badge device of claim 13, wherein a lanyard is used to secure the badge holder to a user.

17. The security badge device of claim 13, wherein the badge holder is configured to be utilized by a healthcare worker, a school employee, or an office employee.

18. The security badge device of claim 13, wherein the retractable cable is attached to a swivel which is then attached to the clip.

19. The security badge device of claim 13, wherein the body component comprises a front surface, a rear surface and surrounding side walls.

20. A method of sending an emergency signal for help when necessary, the method comprising the following steps:
providing a security badge device comprising a body component with a circular button that is color coded;
activating the security badge device;
clipping the security badge device to a user's clothes;
pressing the button to send an alert based on the color displayed; and
sending an alert that tells the staff where the user is in the building and what is needed to assist the user calling for help.
